(19) United States
(12) Patent Application Publication
(10) Pub. No.: US 2022/0076356 A1
(43) Pub. Date: Mar. 10, 2022

(54) CONCENTRATE CORRELATION SYSTEM

(71) Applicant: Radient Technologies Innovations Inc., Edmonton (CA)

(72) Inventors: Michael Cabigon, Edmonton (CA); Jim Seethram, Edmonton (CA); Steven Splinter, North Vancouver (CA); Denis Taschuk, Edmonton (CA)

(21) Appl. No.: 17/238,025

(22) Filed: Apr. 22, 2021

Related U.S. Application Data
(63) Continuation of application No. PCT/IB2019/058958, filed on Oct. 22, 2019.
(60) Provisional application No. 62/749,026, filed on Oct. 22, 2018.
(60) Provisional application No. 62/749,031, filed on Oct. 22, 2018.

(51) Int. Cl. G06Q 50/02; G06F 16/22; G06Q 10/06

(52) U.S. Cl. CPC G06Q 50/02; G06Q 10/0637; G06F 16/2282

(57) ABSTRACT

Systems and methods for correlating a concentrate to growth and biomass properties are provided. Desirable concentrate attributes may therefore be identified as being correlated to certain growth conditions, biomass properties, and extraction and other processing parameters Such positive attributes may include cost and ease of production, as well as therapeutic, aromatic, and intoxicating qualities. Product variables, such as terpene profiles, sensor data from growth to handling facilities, may be used to match the final products with the proper biomass source and processing methods. Such correlation may incorporate artificial intelligence and machine learning techniques to identify correlations, patterns, and trends. As a result, recommendations may be made regarding how to achieve certain desirable attributes in a final product.

### CROSS-REFERENCE TO RELATED APPLICATIONS

The present patent application is a continuation of PCT/IB2019/058958 filed on Oct. 22, 2019 which claims the priority benefit of U.S. provisional patent application No. 62/749,026 filed Oct. 22, 2018 and U.S. provisional patent application No. 62/749,031 filed Oct. 22, 2018, the disclosures of which are incorporated by reference herein.

### BACKGROUND OF THE INVENTION

### 1. Field of the Invention

The present disclosure is generally related to correlating cannabis biomass properties and extraction processing parameters used to produce cannabis extracts with desired attributes in a finished product in which the concentrate is used. More specifically, the present disclosure concerns tracking and correlating parameters related to growth, extraction, and handling to therapeutic and other effects of cannabis products.

### 2. Description of the Related Art

The term cannabis or “cannabis biomass” or simply “biomass” encompasses the Cannabis sativa plant and also variants thereof, including subspecies sativa, indica and ruderalis, cannabis cultivars, and cannabis chemovars (varieties characterised by chemical composition), which naturally contain different amounts of the individual cannabinoids, and also plants which are the result of genetic crosses. The term cannabis is to be interpreted accordingly as encompassing plant material derived from one or more cannabis plants. The term “cannabis extract” or “extract” encompasses any extract of the cannabis biomass (also known as cannabis concentrate or cannabis oil). The term “cannabis product” or “product” encompasses any derivative product derived or produced from cannabis in any form suitable for any delivery method, including for example inhalation or ingestion.

Cannabis biomass contains a unique class of terpeno-phenolic compounds known as cannabinoids or phytocannabinoids, which have been extensively studied since the discovery of the chemical structure of tetrahydrocannabinol (Delta-9-THC), commonly known as THC. Over 113 phytocannabinoids have been identified. Such cannabinoids are generally produced by glandular trichomes that occur on most aerial surfaces of the plant. The cannabinoids are biosynthesized in the plant in acidic forms known as acidic cannabinoids. The acidic cannabinoids may be slowly decarboxylated during drying of harvested plant material. Decarboxylation may be hastened by heating the cannabis biomass, such as when the cannabis biomass is smoked or vaporized.

The principle cannabinoids present in cannabis are the Delta-9-tetrahydrocannabinolic acid (Delta-9-THCA) and cannabidiolic acid (CBDA). The Delta-9-THCA does not have its own psychoactive properties as is, but may be decarboxylated to Delta-9-tetrahydrocannabinol (Delta-9-THC), which is the most potent psychoactive cannabinoid among known cannabinoids. The neutral form of CBDA is cannabidiol (CBD), which is a major cannabinoid substituent in hemp cannabis. CBD is non-psychoactive and is widely known to have therapeutic potential for a variety of medical conditions. The proportion of cannabinoids in the plant may vary from species to species, as well as vary within the same species at different times and seasons. Furthermore, the proportion of cannabinoids in a plant may further depend upon soil, climate, and harvesting methods. Thus, based on the proportion of the cannabinoids present in a plant variety, the psychoactive and medicinal effects obtained from different plant varieties may vary.

Depending upon the psychoactive and medicinal effects obtained from different varieties of the cannabis plant or the different methods of cultivation for cannabis, a specific variety of cannabis may be considered more effective or potent than others (e.g., in providing the desired physiological effect at a desired level in an individual). Similarly, some specific combinations of pharmacologically active compounds in a cannabis variety may be more desirable in comparison to other varieties. When preparing cannabis plant extracts, the retention of the full mix of cannabinoids present in the original plant may be desirable for some varieties, while other varieties may be preferred in altered form due to the variances in the specific cannabinoid composition and concentrations. Such variance is further exacerbated by the presence of certain terpenoid or phenolic compounds, which may have pharmacological activity of their own and which may be desired at different concentrations in different combinations.

Historical delivery methods have involved smoking (e.g., combusting) the dried cannabis plant material. Smoking results, however, in adverse effects on the respiratory system via the production of potentially toxic substances. In addition, smoking is an inefficient mechanism that delivers a variable mixture of active and inactive substances, many of which may be undesirable. Alternative delivery methods such as ingesting typically require extracts of the cannabis biomass (also known as cannabis concentrates, extracts or cannabis oils). Often, cannabis extracts are formulated using any convenient pharmacologically acceptable diluents, carriers or excipients to produce a composition.

The extraction of bioactive or therapeutic compounds from natural biomass sources, including for example plants, has been practiced throughout human history. Plant extracts may contain some or all of the benefits of the plant itself, in a convenient concentrated form. The methods used to prepare the extracts, however, including the form and composition of the starting biomass, the extraction solvent and extraction conditions utilized and the methods and degree of post-extraction processing employed, will result in varying chemical compositions and profiles of the extracts. In addition, these plant extracts are often further formulated into for example food products, topical or cosmetic products or therapeutic products. The final product attributes, including for example organoleptic properties of a food product, or therapeutic properties of a medicinal product, may be greatly influenced by the biomass type, growing and harvesting methods, post-harvesting processing and handling and the extraction methods and conditions used to prepare the concentrates.

There is a need, therefore, for methods to correlate product attributes to growth, biomass, and processing properties.

### SUMMARY OF THE CLAIMED INVENTION

The present invention is concerned with correlating biomass properties, in particular those of cannabis biomass, and extraction methods and conditions with desired attributes in a finished product the concentrate is used in. Desired attributes may include cost and ease of manufacture by producers, organoleptic properties desired by consumers and therapeutic properties desired by caregivers and patients. Biomass properties may include cultivar or mixtures of cultivars and growing, harvesting and post-harvesting handling methods and conditions. Extraction methods may include choice of extraction solvent and conditions and degree and methods of post-extraction processing and purification. Many problems arise when extracting therapeutic compounds from a biomass. For example, how to best leverage food and therapeutic content tracking to determine the best biomass mixture combined with the best practices and methods to produce enhanced specified outcomes? How to best use product variables and sensor data to match finished concentration products with identified correlations of attributes from processing methods? How to best use an AI concentrate profile to therapeutic matching system which focuses on how biomass material, processing techniques and the correlation between them create a desired therapeutic benefit? An artificial intelligence system may be used to calculate the correlations and identify the attributes in the source and processing methods that contribute to desired attributes in the finished product.

Whether grown and extracted for commercial or home use, the production of cannabis products may be analyzed and managed at various stages in order to achieve desired results in a more predictive manner. Desired results may be defined in terms of specific properties (e.g., taste, potency) that are desirable to certain markets or even certain users. In addition, feedback may be used to identify parameters that are correlated to the desired result.

### BRIEF DESCRIPTIONS OF THE DRAWINGS

FIG. 1 illustrates an exemplary network environment in which a system for concentrate correlation may be implemented.

FIG. 2 is a flowchart illustrating an exemplary method for concentrate correlation analytics.

FIG. 3 illustrates an alternative exemplary network environment in which a system for concentrate correlation may be implemented.

FIG. 4 illustrates an alternative exemplary method for concentrate correlation.

FIG. 5 illustrates an exemplary database for tracking concentrate parameters.

### DETAILED DESCRIPTION

Embodiments of the present invention include a system for correlating concentrate products to growth and biomass properties. Such a system may therefore receive data regarding a particular production line from seed, growth to plants, biomass harvest, processing, and handling, extraction, and consumption. Each stage may be managed by different parties that have agreed to share data. In some embodiments, the entire production cycle may be managed by an individual for home use. Data regarding the various stages, however, may be analyzed to identify common properties and parameters during growth, extraction, or processing that tend to result in a product that exhibits desirable attributes and effects. Such common properties and parameters may therefore be used to generate recommendations regarding adjustments to one or more stages of production.

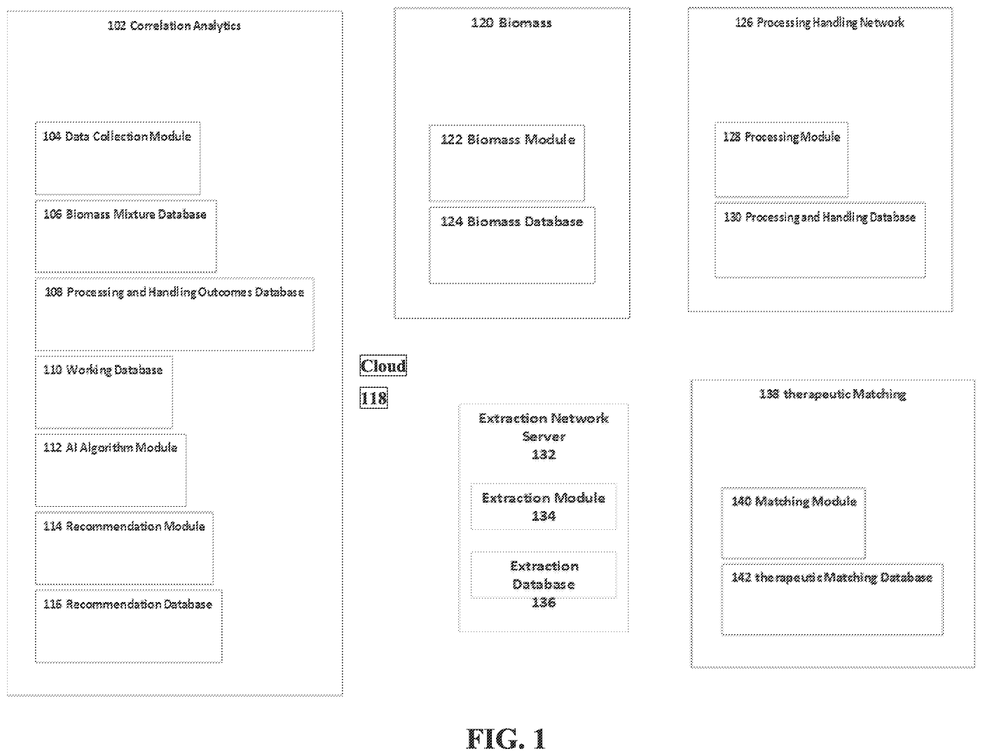

FIG. 1 illustrates an exemplary network environment in which a system for concentrate correlation may be implemented. The network environment may include correlation analytics network server 102, biomass system(s) 120, processing handling network server(s) 126, extraction network server(s) 132, and therapeutic matching device(s) 138, all of which may communicate via communication network or cloud 118.

Correlation analytics network server 102 may be execute its component modules to analyze data collected from the network or cloud 118 in order to identify correlations, patterns, and trends. For instance, correlation analytics network server 102 may find that the particular product attribute (e.g., therapeutic effects on a patient) is more likely to be found in certain cultivars or mix of cultivars, as well as specific extraction processing parameters (e.g., extraction methods or techniques, solvent, conditions employed) that may result in enhanced or higher quality effects. The correlations identified by correlation analytics network server 102 may be used to generate recommendations regarding how to best achieve such effects at various stages, including plant growing, extraction, and other handling processes.

As illustrated, correlation analytics network server 102 may include data collection module 104, biomass mixture database 106, processing and handling outcomes database 108, working database 110, artificial intelligence (AI) algorithm module 112, recommendation module 114, and recommendation database 116.

Data collection module 104 may be executable to collect data from the selected biomass system 120, processing and handling network server 126, extraction network 132, and therapeutic matching devices 138. Such data collected by data collection module 104 may be provided to AI algorithm module 112 to compare and discover correlations between different sets of data regarding different stages from seed to biomass to concentrate/extract to final consumable product. Different properties exhibited at different stages—as indicated by the collected data—may be correlated to each other and to different processing parameters. Such correlations may therefore be used to predict downstream properties and to make recommendations regarding processing parameters for the current production, as well as future products of a similar type.

Data collection module 104 may collect such data from biomass systems 120 (e.g., associated with farms, growers, etc.) as seed data, specific cannabis cultivars, mix of cultivars, growth conditions, harvesting and post-harvest processing, and handling parameters (e.g., physical separation of flowers, leaves, and trim; drying; decarboxylation conditions), storage conditions, and chemical profile data (e.g., cannabinoid content, cannabinoid profile, terpene content, and terpene profile).

Such data from biomass system 120 may include THC and CBD concentrations associated with certain biomass, as well as a recommendation for lowering the THC concentration and increasing the CBD concentration. There may be, for example biomass data base of THC and CBD concentration by processing conditions and by biomass type (cultivar of cannabis etc.). Such complex biomass data may be continuously updated and made searchable (e.g., for searches by data collection module 104). For example, searching tools may allow searches to be performed for a desired THC or CBD concentration, thereby identifying the conditions (e.g., properties and parameters) associated with such concentrations in past productions. Likewise, if changes to the THC or CBD concentration are needed, other processing parameters could be recommended.

The data retrieved by data collection module 104 may be stored in the biomass mixture database 106. Likewise, other data retrieved from other parties and systems may be stored in biomass mixture database 106, including extraction data (e.g., extraction solvent, temperature, duration, and pressure).

Processing and handling data collected by data collection module 104 from processing handling network server 126 may be stored in processing and handling outcomes database 108. Such data may include processing parameters and associated recommendations. For example, the collected data may indicate that a specific biomass is being processed at 30° C. temperatures; the biomass (e.g., having certain identified properties) may further be associated with a recommendation for increasing temperature by 5° C. for an extraction time of 10 minutes in order to achieve more efficient extraction.

Data collection module 104 further obtains extraction data from extraction network server 132 and store such data in working database 110. Such data may include physical properties, cannabinoid concentrations, cannabinoid profiles, and terpene concentrations and profiles. For example, the extraction data may indicate 70% THC and a recommendation for selecting less concentrated THC are received and stored in the working database. In addition, therapeutic data may be associated with the extraction data. Such therapeutic data may include indications of appetite, tumor growth, seizures, etc., retrieved from the therapeutic matching device 138 and stored in the working database 110. For example, the stored data may be received regarding a user who wants to increase appetite by consuming a cannabis-infused product, as well as data regarding the effects thereof. The data collected by data collection module 104—and stored in the various databases—may be used by the AI algorithm module 112 for analysis. Such analysis may identify certain correlations between the received sets of data obtained from biomass systems 120, processing handling network servers 126, extraction network servers 132, and therapeutic matching devices 138.

The AI algorithm module 112 may perform various correlations between the groups of data in order to determine if there is a more efficient or effective method of obtaining desired properties (e.g., therapeutic effect) in a final cannabis product. Such determinations may be based on tracking a variety of different properties, parameters, and effects associated with different production lines. AI algorithm module 112 may identify, for example, that certain cultivars tend to produce more highly concentrated in specific compounds upon extraction, for example, than other cultivars. Likewise, AI algorithm module 112 may identify that the specific compounds is highly correlated to a desired effect among users.

Based on correlations identified by AI algorithm module 112, recommendation module 114 may generate one or more recommendations applicable to adjust a parameter in order to increase the likelihood of achieving an desirable attribute in the final product. The recommendations may pertain to specific cultivars/seeds, biomass processing, extraction processing, and other concentrate processing stages. Recommendation module 114 may send recommendations to different processing systems, therefore, instructing the recipient system to adjust a current processing and handling parameter or techniques applied to a selected biomass mixture in order to more effectively or efficiently produce an extract with a desired therapeutic benefit.

For example, recommendation module 114 may receive correlation data from the AI algorithm module 114. Such correlation data may be geared towards identifying parameters resulting in therapeutic outcomes. As such, the correlation data may be organized and sorted by best therapeutic outcomes (e.g., increasing appetite) by way of a product infused with specified ranges of THC and CBD content as processed under certain processing conditions. Such data from AI algorithm module 114 may identify, for example, that therapeutic data (e.g., increased appetite) is highly correlated to a specific range of THC and CBD concentrations from a particular biomass cultivar processed using particular processing parameters (e.g., temperature).

Previous recommendations may also be retrieved from the recommendation database 116 for comparison. For example, previous recommendations may have specified selecting a different cannabis cultivar with lower THC concentration for the therapeutic benefit of increased appetite. The retrieved previous recommendation may be compared to the correlation data from AI algorithm module 112 and extract property data (e.g., from extraction network server 132) to determine which adjustments (e.g., different processing and handling parameters and techniques) that may enhance the desired extract properties. A new recommendation may therefore be generated by recommendation module 114 based on the determined adjustment. For example, the adjustment may specify increasing extraction temperature by 5° C. or selecting different cultivars having a lower THC level in order to produce extracts with a desired level of therapeutic effect. The recommendation may be implemented and the results tracked to confirm success in increasing appetite. The successes of different recommendations may also be compared to determine which parameters correlate more highly to the desired attribute. The new recommendation generated by recommendation module 114 may thereafter be sent to the biomass system 120, processing and handling network server 126, extraction network server 132, and therapeutic matching device 138 for implementation. For example, the recommendation to select biomass having lower THC levels may be sent to the biomass system 120; a recommendation to increase temperature may be sent to the processing handling network server 126; a commendation regarding a specified extraction concentration may be sent to extraction network server 132, and the recommendation regarding increased appetite result may be sent to the therapeutic matching device 138. The recommendation database 116 may store recommendations that have been generated in association with the desired attribute and the designated recipient system that applies such recommendation.

Biomass system 120 may include biomass module 122 that may track biomass data and biomass database 124 that stores the biomass data. Biomass system 120 may be inclusive of a network of biomass systems 120 tasked to collect data related to different lots of cannabis biomass. The biomass module 122 may send the biomass data stored in biomass database 124 to the data collection module, as well as receives any potential recommendation from the recommendation module 114 regarding any adjustments. The biomass database 124 contains the current properties and compositions of the biomass at the unextracted level.

The biomass module 122 may be configured to track a variety of biomass data, such as cannabis cultivar, growing conditions, post harvesting processing and handling (e.g., physical separation of flowers, leaves and trim, drying or decarboxylation conditions), storage conditions, and chemical profile data (e.g., cannabinoid content and profile and terpene content and profile). For example, data comprising of cultivar THC concentration in biomass may be tracked by biomass module 122, which may further receive a recommendation from the recommendation module 114 (e.g., a recommendation of a lower THC concentration in biomass). Biomass module 122 may send the biomass data (e.g., cultivar and THC concentration) to the data collection module 104.

The processing handling network server 126 may be inclusive of a network of processing and handling network servers for collecting processing and handling data. The processing handling module 128 may send the tracked data stored in local processing and handling databases 130 to the data collection module 110, as well as receive any potential recommendation from the recommendation module 114. The processing and handling database 130 may contain the current techniques and methods of the extraction process.

Processing module 128 may track such data as extraction processing and handling techniques (e.g., temperatures, duration). For example, processing module 128 may identify that an initial processing temperature of 30 C is being used on a current biomass. The processing module 128 may thereafter receive a recommendation from the recommendation module regarding an alteration to the current processing and handling parameters (e.g., temperature). For example, the recommended adjustment may specify increasing temperature by 5 C after an initial 30 C processing temperature. Processing module 128 may also send data stored in the processing and handling database 130 and associated recommendation to the data collection module. For example, the data comprising of the initial temperature of 30 C and the recommendation of increasing the temperature by 5 C may be sent to the data collection module 104.

Meanwhile, the extraction network server 132 may collect and send extraction-related data to data collection module 104. The extraction module 134 may send extract data stored in extraction database 136 to the data collection module 110, as well as receive any potential recommendation from the recommendation module 114. The extraction database may contain the current yields and outcome results of the extraction process.

Extraction module 134 may track extraction data, such as yield percentage, quality, and content. Such data may be provided to the extraction database 136 for storage. For example, such data may include 70% THC concentration for extracts from a certain biomass. A recommendation may be received from the recommendation module 114. For example, a recommendation for lowering THC concentration to 50% THC results for the therapeutic benefit of increasing appetite may be received by extraction module 134. The extraction data (e.g, 70% THC, CBD concentrations) may be sent to the data collection module 104.

Therapeutic matching device 138 may be inclusive of a network of devices that can collect therapeutic data from one or more users (e.g., before and after consumption of a product). The matching module 140 may send the data stored in therapeutic matching database 142 to the data collection module 100, as well as receives any potential recommendation from the recommendation module 114. The therapeutic matching database 142 may contain the extract properties and therapeutic uses of such extracts.

Matching module 140 may track therapeutic data, such as indicators of indigestion, tumor growth, seizures, etc., and store such data in the therapeutic matching database 142. For example, such therapeutic data may include user preferences or desired effects (e.g., increased appetite). A recommendation may be received from the recommendation module 114 regarding increasing appetite. Therapeutic data (e.g., regarding indigestion, tumor growth, or seizures) may be sent to the data collection module 104.

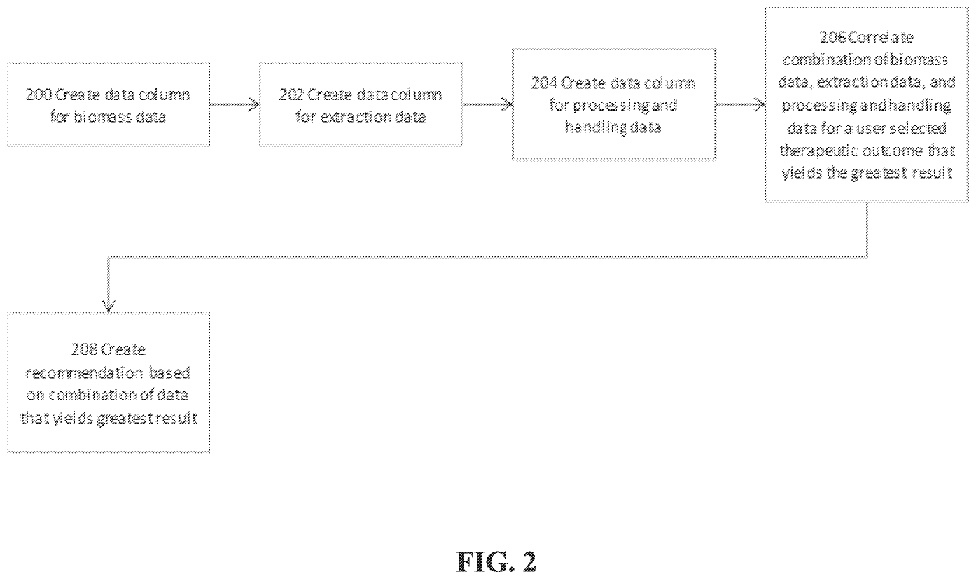

FIG. 2 is a flowchart illustrating an exemplary method for concentrate correlation analytics. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The method may begin with step 200, in which the data column for biomass data may be created for correlation analytics. For example, the biomass data may include cannabis cultivar or mix of cultivars, growing conditions, post harvesting processing and handling (e.g., physical separation of flowers, leaves and trim, drying or decarboxylation conditions), storage conditions, and chemical profile data including for example cannabinoid content and profile and terpene content and profile. Such biomass data collected from biomass systems 120 may be stored at step 200.

In step 202, a corresponding column may be created and populated for extraction data for use in correlation analytics. Such data may include physical properties, and chemical profile including for example cannabinoid content and profile and terpene content and profile.

In step 204, a corresponding column is likewise created and populated for processing and handling data for use in correlation analytics. Such data may include the extraction solvent used, the extraction conditions employed, and the degree and methods of post-extraction processing, purification and formulation.

In step 206, the combination of the data columns may be analyzed to identify patterns associated with desired properties (e.g., efficient combination of biomass, processing, and extract properties, desired product attribute or therapeutic outcome). Such analysis may be performed by AI algorithm module 112 upon receiving the data collected from the various systems, including biomass data, processing and handling data, extraction data, and therapeutic matching data. For example, the data comprising biomass properties, extraction conditions and extract properties, and increased appetite are received from the data collection module 104. The biomass data, processing and handling data, extraction data, and therapeutic data may be compared across a variety of different properties and parameters to identify correlations. Such correlations may include patterns and relationships, for example, between different selections of biomasses, processing and handling techniques, and extraction yields with therapeutic results. For example, the correlation between lower THC levels and temperature increase are determined to be highly correlated with a therapeutic benefit of increased appetite.

Similarly, correlation engines may be used to determine quality and yield based on input parameters and process parameters of an industrial process. Once the correlation data is identified and organized (e.g., by best therapeutic outcome), such correlations may be used to generate recommendations in step 208.

In step 208, a recommendation may be created based on the correlation results identified in step 206. For example, a combination of cultivar, harvesting and post-harvesting process and extraction processing, creates a therapeutic benefit of alleviating pain or increasing appetite. One or more adjustments may be recommended to the biomass system 120, processing and handling network servers 126, extraction network servers 132, or therapeutic matching devices 138 in order to contribute to a desired therapeutic result. For example, the correlation data may be organized by increased appetite, so as to identify the properties and parameters associated with the best therapeutic outcome. Recommendation module 114 may thereafter use the correlation data to create a recommendation (e.g, to increase efficiency of the extraction yield).

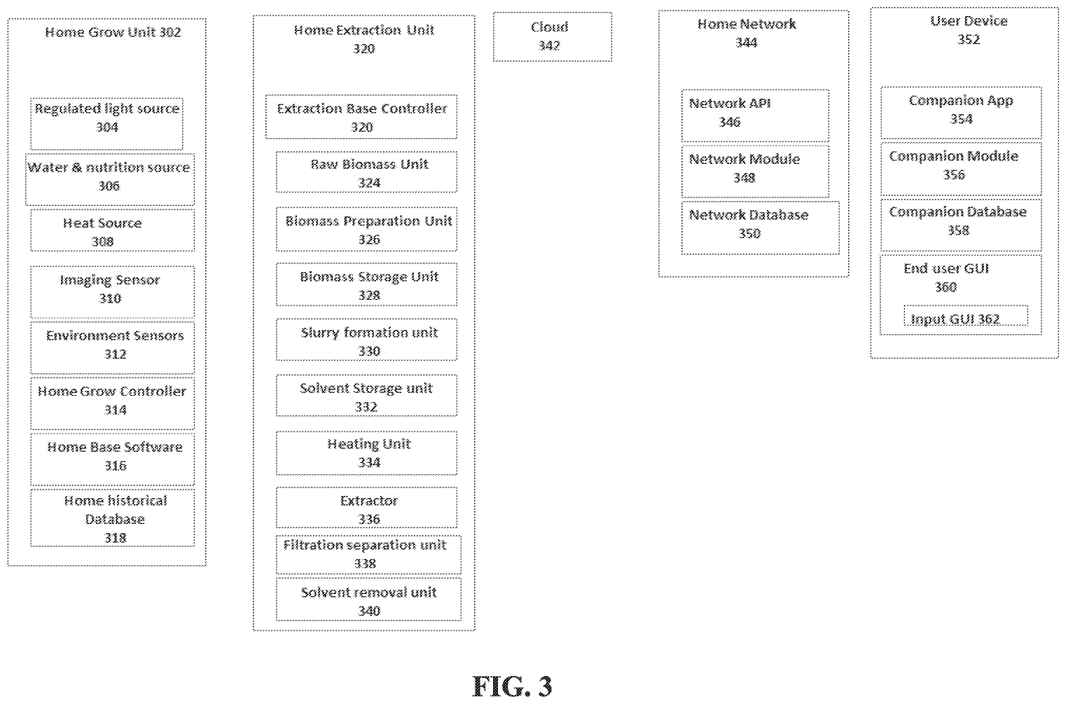

FIG. 3 illustrates an alternative exemplary network environment in which a system for concentrate correlation may be implemented. Such a network environment may be associated with an individual seeking to grow, extract, and make their own products. The illustrated system provides tools for tracking and correlating data in order to achieve and optimize processes for desired outcomes or attributes. As illustrated, the network environment may include a home grow unit 302, home extraction unit 320, cloud 342, home network 344, and user device 352.

Home grow unit 302 may include various components that may be used in growing cannabis plants, as well as components for tracking properties and parameters of such growth. As illustrated, home grow unit 302 may include regulated light source 304, water & nutrition source 306, heat source 308, imaging sensor 310 (e.g., cameras or optical sensors), environment sensor 312 (e.g., temperature sensors, humidity sensors), home grow controller 314, home base software 316, and home historical database 318. Such data tracked by home grow unit 302 may be similar to that tracked by biomass system 120 discussed herein. Instead of having to collect data from multiple different parties and systems, however, home grow unit 302 may be able to detect data regarding the local grow conditions, as well as store the data locally as well in home historical database 318.

Regulated light source 304 may be configured to generate light at wavelengths suitable for cannabis growth. Water and nutrition source 306 may be configured to provide water and nutrients to cannabis plants. Imaging sensor 310 may takes images of the plant over time at different stages of growth and to provide the images to the home historical database 318 for storage. Similarly, environment sensors 312 may track plant growth in association with grow conditions and send such information to the home historical database 318 for storage. Exemplary environment sensors 312 may include sensors for detecting and measuring amounts of moisture, light, temperature, gas (CO2), etc.

Home grow controller 314 may send the instructions to the various components in order to control and adjust conditions of growth, as well as to track status thereof. For example, instructions may be sent to imaging sensor 310 to capture images of the plant during growth. Home grow controller 314 may further run an imaging analysis on the captured images to identify current plant properties (e.g., percent of pistils that have darkened). Similar to how correlation analytics server 102 may analyze data to identify correlations and generate recommendation, the data tracked by home grow unit 302 may be used by home grow controller 314 to generate recommendations regarding how to adjust grow parameters in order to best achieve desired results. Harvest may be recommended when 60-70% of pistils have darkened for highest levels of THC. Another example, harvest may also be recommended when 70-90% of stigma (hairs) have darkened for a more calming, anti-anxiety effect, as some THC turns into cannabinol (CBN), which is associated with more calming effects.

In another example, the home grow controller 314 may analyze macro shots from the imaging sensor 310 to determine THC levels by means of evaluating visible trichome. As an example, the trichomes of the plant may be observed to change appearance from clear to opaque and eventually to amber. During this change, the trichomes may reach their maximum THC content, which may then begin to break down into CBN due to exposure to oxygen and UV rays. Imaging analysis may therefore be performed by images captured by imaging sensor 310 in order to determine when the end of a grow cycle for a given plant is reached, so as to recommend when to start extraction. Once the THC levels are optimal for harvesting based on desired end product, for example, the home grow controller 314 may recommend that extraction begin, as well as recommend extraction parameters (e.g., amount of solvent per weight of biomass to use for extraction). Home historical database 318 may store imaging and sensor data captured by the different sensors (e.g., imaging sensor 310, environment sensor 312) in the home grow unit 302. Such data may be stored for further analysis and use in generating recommendation regarding growth and extraction.

Home extraction unit 320 may be used for the extraction of cannabinoids (e.g., THC, CBD) from cannabis plants at specified quality levels and yields indicated by the companion app 354 and the amount of solvent indicated by the home grow controller 314. The home extraction unit 320 may include extraction base controller 320, raw biomass unit 324, biomass preparation unit 326, biomass storage unit 328, slurry formation unit 330, solvent storage unit 332, heating unit 334, extractor 336, filtration separation unit 338, and solvent removal unit 340. Home extraction unit 320 may track extraction data and otherwise perform extraction operations similar to those performed by extraction apparatuses controlled or managed by extraction network server 132.

Extraction base controller 320 may regulate extraction parameters based on information received from the home grow unit 307. Extraction base controller 320 may check if companion app 354 has sent any order to override the automation of the grow-extract process. If the companion app 354 does send user-preferred extraction parameters (e.g., amount of solvent, energy of extractor, etc.) that are different form automated parameters, extraction base controller 320 may override the automated parameters. Such override may include identifying how to control or adjust grow or extraction conditions to comply with the user-preferred parameters. As such, extraction base controller 320 may implement such identified control or adjusted parameters to regulate home extraction unit 320. Such controlled or adjusted parameters may include an amount of solvent, microwave energy range, temperature, time, etc., to achieve extraction conditions.

Raw biomass unit 324 may store the raw cannabis biomass following harvest. Biomass preparation unit 326 may prepare the raw biomass (e.g. drying, decarboxylating, grinding). Biomass storage unit 328 may store the prepared biomass. Slurry formation unit may form a slurry by mixing the prepared biomass with a solvent at step 130. Solvent storage unit 332 may store the solvent. Heating unit 334 may heat or cool the slurry (e.g., using microwave, radiofrequency, electromagnetic, electrical steam, etc.). Extractor 336 may be where the slurry is exposed to heat from the heating unit. Such heat may facilitate extraction of certain compounds from the biomass. Following application of the heat, therefore, the slurry may include a spent biomass (from which the compounds have been extracted), along with a mixture of the solvent and the extracted compounds. Filtration and separation unit 338 may filter and separate the spent biomass from the solvent and extract. Solvent removal unit 340 may remove and recover the solvent from the extract.

Cloud 342 may include any communication network known in the art, including the Internet which is a global system of interconnected computer networks that use the Internet protocol suite (TCP/IP) to link devices worldwide. Cloud 342 may be inclusive of a variety of communication networks, including private, public, academic, business, and government networks of local to global scope as linked by a broad array of electronic, wireless, and optical networking technologies. The Internet carries a vast range of information resources and services, such as the inter-linked hypertext documents and applications of the World Wide Web (WWW), electronic mail, telephony, and file sharing. As such, cloud 342 may be used for the various devices of FIG. 3 to communicate with each other, as well as with other information sources external to the network environment of FIG. 3.

Home network 344 may contribute to selecting and recommending parameters for grow and extraction processes performed by home grow unit 302 and home extraction unit 320, respectively. Home network 344 may include network API 346, network module 348, and network database 350. Network API 346 may allow different applications and device of FIG. 3 to communicate with each other.

Network module 348 may be executable to process user preferences to identify and select the optimal growing parameters for a desired result (e.g., maximize THC extraction). Network module 348 may also generate recommendations based on such parameters and provide the same to home grow unit 302 or home extraction unit 320 for automated implementation, as well as to user device 352 for user implementation. Network module 348 may receive user input for selection of final product/extract results from user device 352 and retrieve from network database 350 optimal grow parameters for selected biomass profile. Further, network module 348 may be executable to provide recommended grow parameters to home grow unit and companion app 354. Network database 350 may store grow parameters for specific biomass profiles.

User device 352 may be inclusive of any user device known in the art, including computing devices, mobile devices, tablet devices, etc., for communicating via the cloud 342. User device 352 may include companion app 354, companion module 356, companion database 358, end user GUI 360, and input GUI 362.

Companion app 354 may be an application that allows the user to specify a desired end product and receives updates and information about the optimal grow parameters and the progress of the grow/extract processes by means of GUI 360. Using companion app 354, the user may also be able to manually override the automation of the extract process and manually indicate the preferred extract parameters. Companion database 358 may store recommendations, imaging sensor data and type of control (automatic/manual) for the extraction process. End user GUI 360 may show updates about the grow/extract progress, and input GUI may receive user instructions (e.g., to override the automatic processing of the biomass profile into final products). Specifically, input GUI 362 may receive user input regarding preferred extraction conditions.

For example, companion app 354 may request via end user GUI 360 that user input desired product/extract results (e.g. product type such as brownies, ethanol extract.) into input GUI 362. Companion app 354 may receive recommended grow parameters, as well as information from the home network 344 to inform user of the progress of the grow process. Companion app 354 may provide companion database 358 data for storage regarding the grow and extract progress updates. In addition, companion app 354 may interact with the home grow unit 302 or home extraction unit 320 to determine recommended parameters in order to achieve specified types of results. Companion app 354 may also receive information from home network 344 about processing conditions and progress updates and present the same via end user GUI.

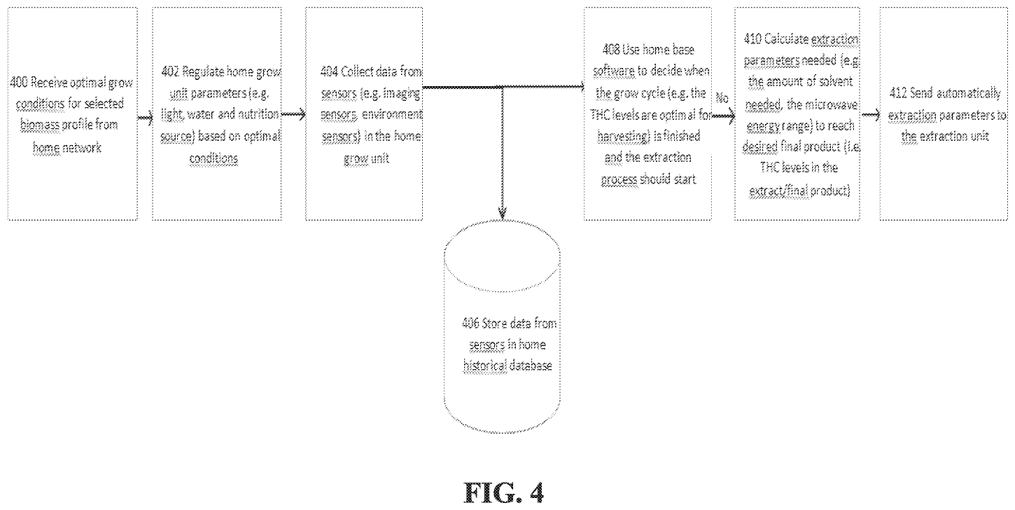

FIG. 4 illustrates an alternative exemplary method for concentrate correlation, which may be performed by home grow controller 314. In step 400, home grow controller 314 may receive optimal grow conditions for selected biomass profile from home network 344.

In step 402, home grow controller 314 may regulate home grow unit parameters (e.g. light, airflow, humidity, water and nutrition source) based on optimal conditions. In step 404, home grow controller 314 may collect data from the sensors (e.g., imaging sensors 310, environment sensors 312) in the home grow unit 302.

In step 406, home grow controller 314 may store data from the sensors in home historical database 318. In step 408, home grow controller 314 may use home base software to decide when the grow cycle (e.g., the THC levels are optimal for harvesting) is finished and when the extraction process is recommended to start. The home base software may use images from the home historical database 318 for comparison. Since images of past growth are taken by time from many growth cycles, the data associated with past sequences can be compared to the current sequence.

In addition, data may be stored in the home historical database 318 about how successful the past sequences were (e.g., from user input entered via input GUI 362 in conjunction with companion app 354 in the user device 352). In this way, the home base software can recommend when the cycle for growth should stop in step 208. In step 410, home grow controller 314 may calculate extraction parameters needed (e.g. the amount of solvent needed, the microwave energy, the temperature, the time) to reach desired final product (i.e. THC levels in the extract/final product), these parameters have been stored from past runs, in the historical database (not shown). The extraction parameters may also related to past success runs, where success can be defined by specified parameters from the extraction (e.g. yield or purity) or could be defined by context-related data maintained by the companion app 354. In step 412, home grow controller 314 may send automatically extraction parameters to the home extraction unit 320.

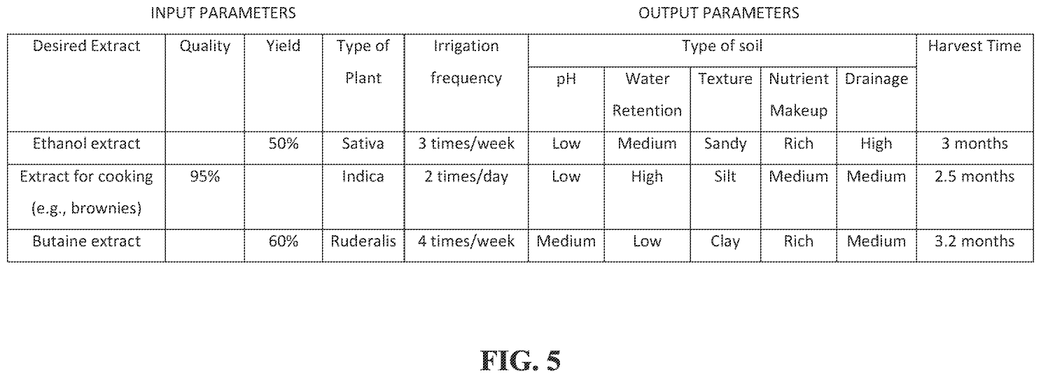

FIG. 5 illustrates an exemplary database 500 for tracking concentrate parameters (e.g., network database 350). As illustrated, database 500 stores data related to desired extract, quality level, yield, type of plant, irrigation frequency, type of soil, harvest time, pH, water retention, texture, nutrient makeup, drainage, airflow, and humidity.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method for correlating stage properties and parameters with desired attributes, the method comprising:
receiving a preference regarding a desired attribute in an end product;
retrieving information sent from a plurality of devices over a communication network regarding a current production, wherein the information from each device concerns a different stage of the current production;
creating a table that stores the retrieved information concerning the different stages of the current production, wherein the table is populated with the retrieved information from the devices;
comparing the created table to data regarding one or more past productions, wherein the comparison identifies at least one parameter that is correlated to the desired attribute; and
generating a recommendation to adjust the current production in accordance with the at least one identified parameter.

2. The method of claim 1, wherein the retrieved information include at least one of biomass data, processing and handling data, extraction data, and therapeutic data.

3. The method of claim 1, wherein the at least one identified parameter concerns plant growth, and the recommendation is transmitted over a communication network to a designated grower device.

4. The method of claim 1, wherein the at least one identified parameter concerns biomass processing and handling, and the recommendation is transmitted over a communication network to a designated processing and handling device.

5. The method of claim 1, wherein the at least one identified parameter concerns extraction, and the recommendation is transmitted over a communication network to a designated extraction device.

6. The method of claim 1, wherein the recommendation includes instructions executable to automatically implement the adjustment in accordance with the at least one identified parameter.

7. The method of claim 1, further comprising sorting the table based on the desired attribute specified by the received preference.

8. The method of claim 7, wherein identifying the at least one parameter is based on the at least one parameter being more correlated to the desired attribute than other parameters as indicated by the sorted table.

9. The method of claim 1, further comprising receiving user input indicative of a different adjustment, and overriding the recommendation based on the user input.

10. A system for correlating stage properties and parameters with desired attributes, the system comprising:
a communication network interface that communicates over a communication network to:
receive a preference regarding a desired attribute in an end product, and
retrieve information sent from a plurality of devices over a communication network regarding a current production, wherein the information from each device concerns a different stage of the current production;
an analytics module stored in memory and executable by a processor to:
create a table that stores the retrieved information concerning the different stages of the current production, wherein the table is populated with the retrieved information from the devices,
compare the created table to data regarding one or more past productions, wherein the comparison identifies at least one parameter that is correlated to the desired attribute, and
generate a recommendation to adjust the current production in accordance with the at least one identified parameter.

11. The system of claim 10, wherein the retrieved information include at least one of biomass data, processing and handling data, extraction data, and therapeutic data.

12. The system of claim 10, wherein the at least one identified parameter concerns plant growth, and the communication network interface transmits the recommendation over the communication network to a designated grower device.

13. The system of claim 10, wherein the at least one identified parameter concerns biomass processing and handling, and the communication network interface transmits the recommendation over the communication network to a designated processing and handling device.

14. The system of claim 10, wherein the at least one identified parameter concerns extraction, and the communication network interface transmits the recommendation over the communication network to a designated extraction device.

15. The system of claim 10, wherein the recommendation includes instructions executable to automatically implement the adjustment in accordance with the at least one identified parameter.

16. The system of claim 10, wherein the analytics module is further executable to sort the table based on the desired attribute specified by the received preference.

17. The system of claim 16, wherein the analytics module identifies the at least one parameter based on the at least one parameter being more correlated to the desired attribute than other parameters as indicated by the sorted table.

18. The system of claim 10, wherein the communication network interface receives user input indicative of a different adjustment, and wherein the recommendation is overridden based on the user input.

19. A non-transitory, computer-readable storage medium, having embodied thereon a program executable by a processor to perform a method for correlating stage properties and parameters with desired attributes, the method comprising:
receiving a preference regarding a desired attribute in an end product;
retrieving information sent from a plurality of devices over a communication network regarding a current production, wherein the information from each device concerns a different stage of the current production;
creating a table that stores the retrieved information concerning the different stages of the current production, wherein the table is populated with the retrieved information from the devices;
comparing the created table to data regarding one or more past productions, wherein the comparison identifies at least one parameter that is correlated to the desired attribute; and
generating a recommendation to adjust the current production in accordance with the at least one identified parameter.
